(19) United States
(12) Patent Application Publication
(10) Pub. No.: US 2010/0325696 A1
(43) Pub. Date: Dec. 23, 2010

(54) SYSTEM FOR AUTHENTICATION OF CONFIDENCE LINK AND METHOD FOR AUTHENTICATION AND INDICATING AUTHENTICATION THEREOF

(76) Inventors: Jong-Hong Jeon, Daejeon (KR); Won-Suk Lee, Daejeon (KR); Kang-chan Lee, Daejeon (KR); Seung-Yun Lee, Daejeon (KR); Min-Kyo In, Daejeon (KR); Tae-Wan You, Daejeon (KR); In-Dong Jang, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/518,058

(22) PCT Filed: Dec. 6, 2006
(86) PCT No.: PCT/KR2006/005253

§ 371 Date: Jun. 5, 2009

(51) Int. Cl. G06F 21/00; G06F 15/16

(52) U.S. Cl. 726/3; 726/2

(57) ABSTRACT

In a certified link authentication system, a terminal parses a web page and extracts markup information for a certified link. In addition, the terminal transmits the extracted markup information to a certified link authentication server. The certified link authentication server authenticates the certified link from the markup information of the certified link transmitted from the terminal, and transmits an authentication result to the terminal. The terminal marks the authenticated certified link with a certified mark, renders the web page, and displays it to the user.

### TECHNICAL FIELD

The present invention relates to a certified link authentication system, an authentication method, and an authentication indicating method thereof.

### BACKGROUND ART

Many people use the Internet by using various terminals including a desktop computer, a mobile phone, and a TV. A user inputs a uniform resource locator (URL) to an address input window or clicks a link included in an e-mail to access various websites on the Internet. The webpage obtained by the access requires the user to input personal information including user identification (ID), passwords, name, credit card numbers, and social security numbers. However, various methods (e.g., a phishing method) for cheating and stealing the personal information have started to appear.

The phishing method is performed to steal the personal information by enticing the user to visit a predetermined website, a site formed to be similar to an original website, or an original website, to input the personal information including the passwords and the credit card numbers.

Generally, in a web browsing process, while contents in a predetermined web page are rendered to be shown, links expressed as hyperlinks including an image, a motion picture, and a text are shown. However, the hyperlink is expressed by using designated words or sentences so include a universal resource identifier (URI) for the hyperlink, and information on the URI is expressed as additional information, in the web browsing process. It is difficult to determine whether the website includes reliable contents and whether a predetermined hyperlink indicates a reliable server. Accordingly, a user may easily access an illegal website by the vicious phishing method. That is, personal identification information may be easily leaked out.

### DISCLOSURE

### Technical Problem

The present invention has been made in an effort to provide a certified link authentication system for preventing personal information leakage, an authentication method, and an authentication displaying method.

### Technical Solution

According to an exemplary embodiment of the present invention, in a method for displaying an authenticated certified link on a web page requested by a terminal from a web server, the web page is parsed. Markup information for a certified link is extracted, the extracted markup information is used, authentication for the certified link is requested, the authenticated certified link is marked with a certified mark, the web page including the certified link marked with the certified mark is rendered, and the web page is displayed.

According to another exemplary embodiment of the present invention, in a method for authenticating a certified link of a web page requested by a terminal in a certified link authentication server that accesses a plurality of terminals through the Internet, certified link authentication information of the web page received from a terminal of a certified link registered user among the plurality of terminals through the Internet is registered, a request for authenticating the certified link is received from a terminal of a certified link authentication requesting user among the plurality of terminals, the certified link requested by the terminal is authenticated based on the registered certified link authentication information, and an authentication result is transmitted to the terminal.

According to a further exemplary embodiment of the present invention, a terminal for displaying a certified link on a web page requested from a web server includes a rendering engine unit, a certified link determination unit, and a graphic interface unit. The rendering engine unit parses the web page to extract the certified link, marks an authenticated certified link with a certified mark, and marks a certified link that is not authenticated with a non-certified mark. The certified link determination unit requests authentication for the extracted certified link, and transmits an authentication result to the rendering engine unit. The graphic interface unit displays the certified link marked with the certified mark by the rendering engine unit.

According to a still further exemplary embodiment of the present invention, a certified link authentication server for authenticating a certified link of a web page requested by a terminal includes a user authentication unit, a registration information storage unit, a registration information input unit, and a certified link authentication processing unit. The user authentication unit authenticates a certified link registered user requesting registration of the certified link. The registration information storage unit stores certified link registered user information and certified link authentication information. The registration information input unit receives the certified link authentication information from the certified link registered user, and stores the certified link authentication information in the registration information storage unit. The certified link authentication processing unit authenticates the certified link of the web page requested by the terminal based on the stored certified link authentication information and transmits an authentication result to the terminal.

### DESCRIPTION OF DRAWINGS

FIG. 1 is a diagram representing a certified link authentication system according to an exemplary embodiment of the present invention.

FIG. 2 is a diagram representing a web browsing module shown in FIG. 1.

FIG. 3 is a diagram representing a certified link authentication server shown in FIG. 1.

FIG. 4 is a diagram representing an operation of the web browsing module shown in FIG. 1.

FIG. 5 and FIG. 6 are diagrams respectively representing certified links marked with a certified mark and a non-certified mark.

FIG. 7 and FIG. 8 are diagrams of common gateway interface (CGI) submit buttons respectively marked with the certified mark and the non-certified mart.

FIG. 9 and FIG. 10 are diagrams representing address display windows respectively marked with the certified mark and the non-certified mark.

FIG. 11 is a diagram representing an operation of a registration information input unit of the certified link authentication server shown in FIG. 3.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements. Further, the word “block” will be understood to indicate a unit for processing a predetermined function or operation, which may be realized by hardware, software, or a combination thereof.

A certified link authentication system according to an exemplary embodiment of the present invention, an authentication method, and an authentication indicating method thereof will be described.

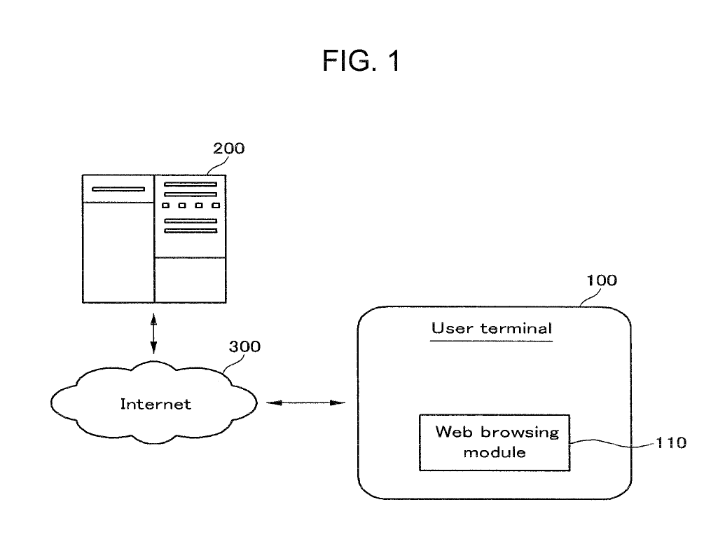

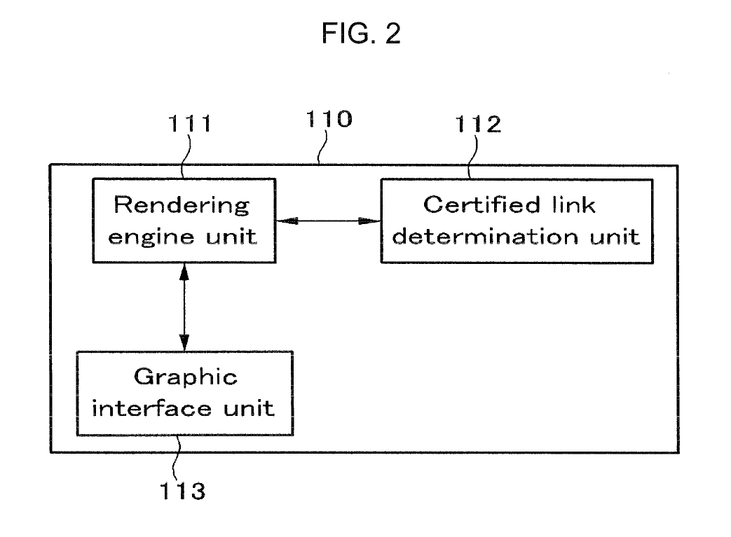

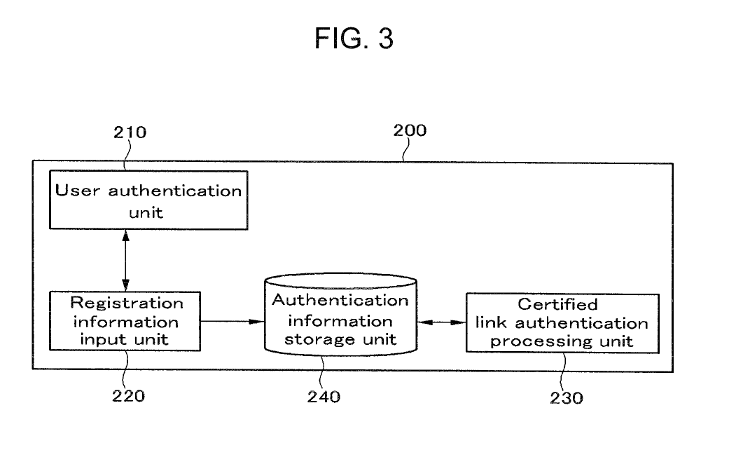

FIG. 1 is a diagram representing a certified link authentication system according to the exemplary embodiment of the present invention, and FIG. 2 is a diagram representing a web browsing module shown in FIG. 1. FIG. 3 is a diagram representing a certified link authentication server shown in FIG. 1.

As shown in FIG. 1, the certified link authentication system includes a user terminal 100 including a web browsing module 110 and a certified link authentication server 200. In this case, the user terminal 100 may access the certified link authentication server 200 through an Internet 300.

As shown in FIG. 2, the web browsing module 110 includes a rendering engine unit 111, a certified link determination unit 112, and a graphic interface unit 113. The rendering engine unit 111 extracts and parses a web page received through the Internet and extracts only a certified link. That is, a predetermined tag or characteristic information that indicates the certified link is included in a markup language that describes the web page. Markup languages include hypertext markup language (HTML), eXtensible HTML (XHTML), compact HTML (cHTML), and wireless markup language (WML). Accordingly, the rendering engine unit 111 may extract the certified link from the parsed webpage based on markup information that indicates the certified link.

In addition, the rendering engine unit 111 marks an authenticated certified link with a certified mark, and marks a certified link that is not authenticated with a non-certified mark. In this case, the rendering engine unit 111 may block a link connection for the certified link marked with the non-certified mark, and may display a warning sentence on a window to which user information is input in the web page including the certified link marked with the non-certified mark. The certified link determination unit 112 requests the certified link authentication server 200 to authenticate the extracted certified link, and transmits an authentication result from the certified link authentication server 200 to the rendering engine unit 111. The graphic interface unit 113 displays the certified link marked with the certified mark on a user screen.

The certified link authentication server 200 records, stores, and provides authentication information for the certified link. As shown in FIG. 3, the certified link authentication server 200 includes a user authentication unit 210, a registration information input unit 220, a certified link authentication processing unit 230, and an authentication information storage unit 240.

The user authentication unit 210 authenticates a certified link registered user who requests an authentication registration request page for the certified link. The registration information input unit 220 receives certified link authentication information from the authenticated certified link registered user, determines whether the certified link authentication information overlaps with input certified link registration information, and stores the certified link authentication information in the authentication information storage unit 240. The certified link authentication processing unit 230 receives the authentication request for the certified link from the certified link determination unit 112, authenticates the certified link, and transmits an authentication result to the certified link determination unit 112. The authentication information storage unit 240 stores registered user information and the certified link authentication information. The certified link authentication information may include a link connection IP list, a link connection keyword list, an allowed web server IP list, an allowed web server uniform resource locator (URL) list, and a usage limitation state.

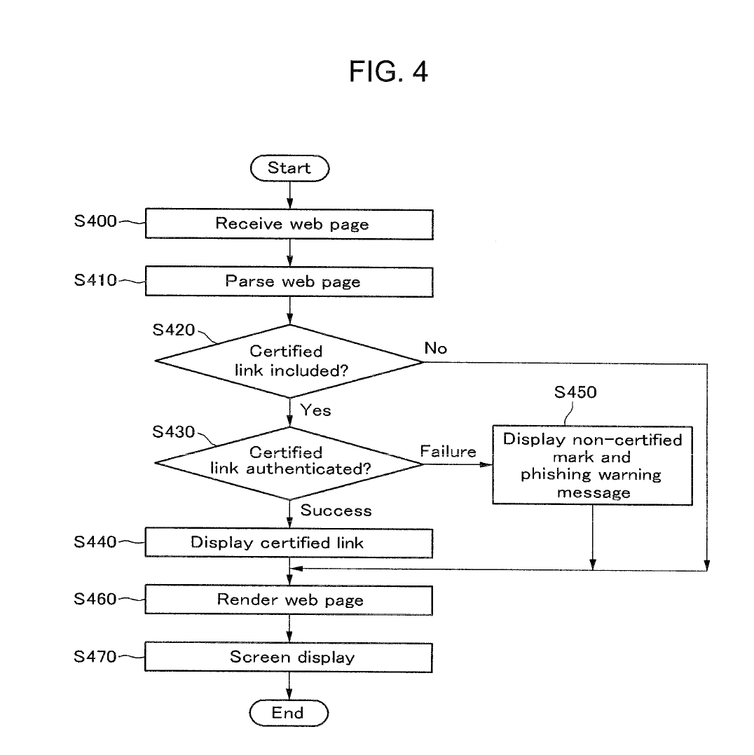

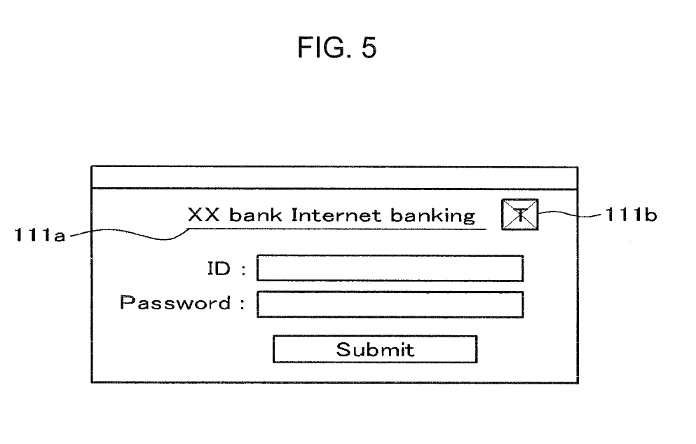

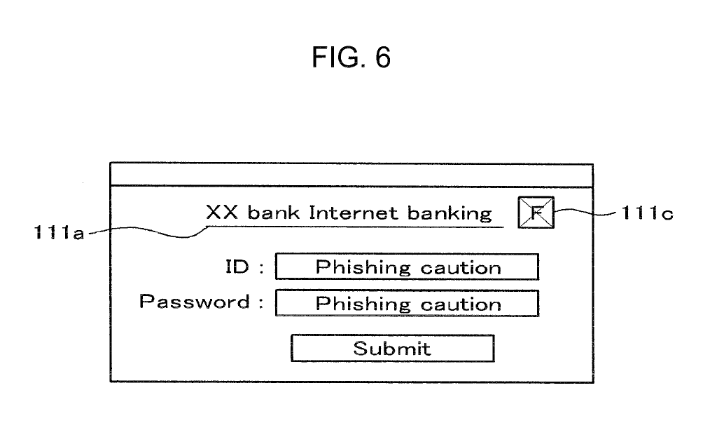

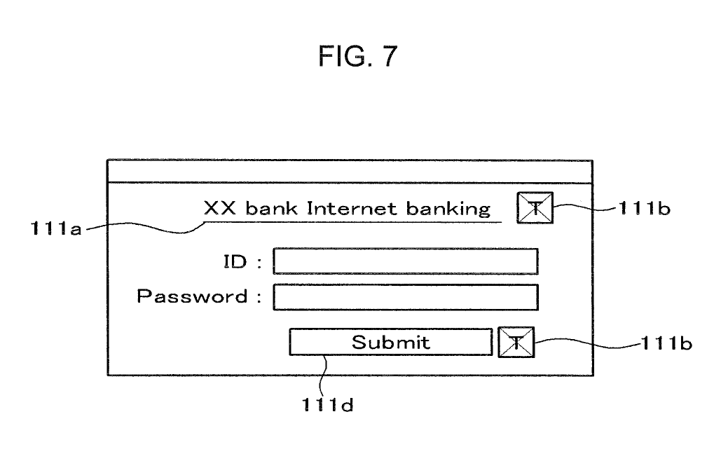

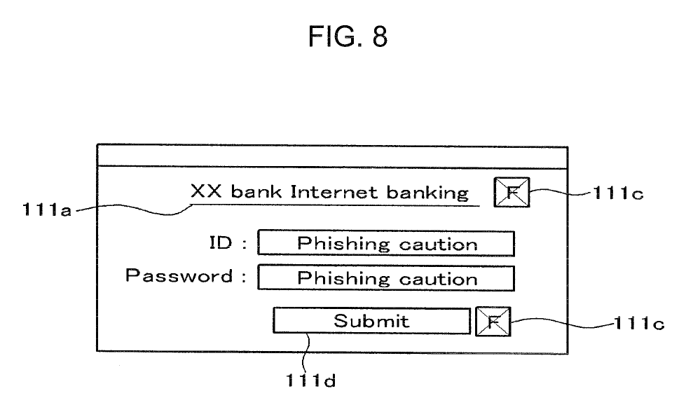

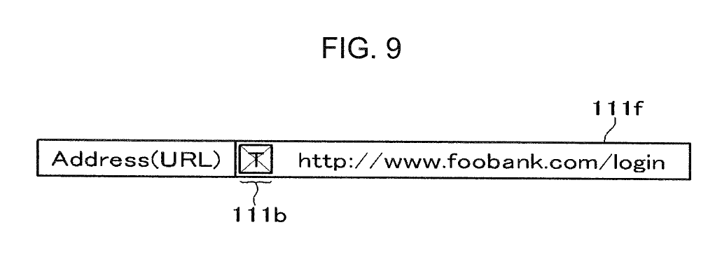

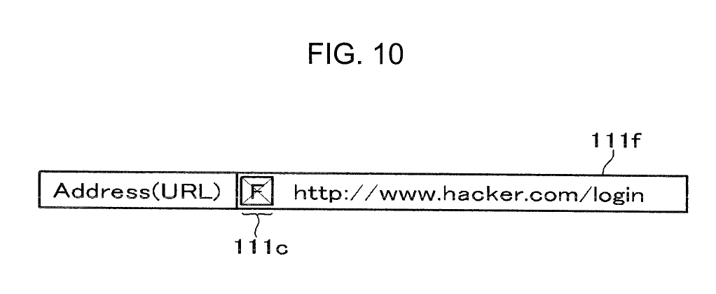

FIG. 4 is a diagram representing an operation of the web browsing module shown in FIG. 1, and FIG. 5 and FIG. 6 are diagrams respectively representing the certified links marked with the certified mark and the non-certified mark. FIG. 7 and FIG. 8 are diagrams of common gateway interface (CGI) submit buttons respectively marked with the certified mark and the non-certified mark. FIG. 9 and FIG. 10 are diagrams representing address display windows of the web pages respectively marked with the certified mark and the non-certified mark.

As shown in FIG. 4, the rendering engine unit 111 receives the requested web page from the web server through the Internet and parses the received web page in steps S400 to S410. The certified link determination unit 112 determines in step S420 whether the parsed web page includes the markup information for the certified link. In this case, when the parsed web page includes the markup information for the certified link, the certified link determination unit 112 transmits the corresponding markup information to the certified link authentication server 200 to request authentication for the certified link in step S430. When the certified link is authenticated by the certified link authentication server 200, the rendering engine unit 111 marks a certified link 111a with a certified mark T 111b as shown in FIG. 5 in step S440. In addition, when the certified link is not authenticated by the certified link authentication server 200, the rendering engine unit 111 marks the certified link 111a with a non-certified mark F 112c as shown in FIG. 6, and displays a phishing warning message “phishing caution” in step S450. When it is determined in step S420 that the web page does not include the markup information for the certified link, or when the certified link determination unit 112 finishes marking the certified link with the certified mark or the non-certified mark, the rendering engine unit 111 performs a rendering process for the corresponding web page in step S460.

The graphic interface unit 113 displays the webpage rendered by the rendering engine unit 111 in step S460 on a user screen in step S470.

In addition, the rendering engine unit 111 may mark a CGI submit button 111d having a certified link value with the certified mark T 111b as shown in FIG. 7 while marking the certified link 111a with the certified mark T 111b, and the rendering engine unit 111 may mark the CGI submit button 111d having a non-certified link value with the non-certified mark F 111c as shown in FIG. 8 while marking the certified link 111a with the non-certified mark F 111c. In this case, a warning message “phishing caution” may be displayed on an input window in which the user information is input.

As shown in FIG. 9, the rendering engine unit 111 may mark an address display window 111f of the web page having the certified link with the certified mark T 111b. In a like manner, as shown in FIG. 10, the rendering engine unit 111 may display the address display window 111f of the web page having the non-certified link marked with the non-certified mark F 111c.

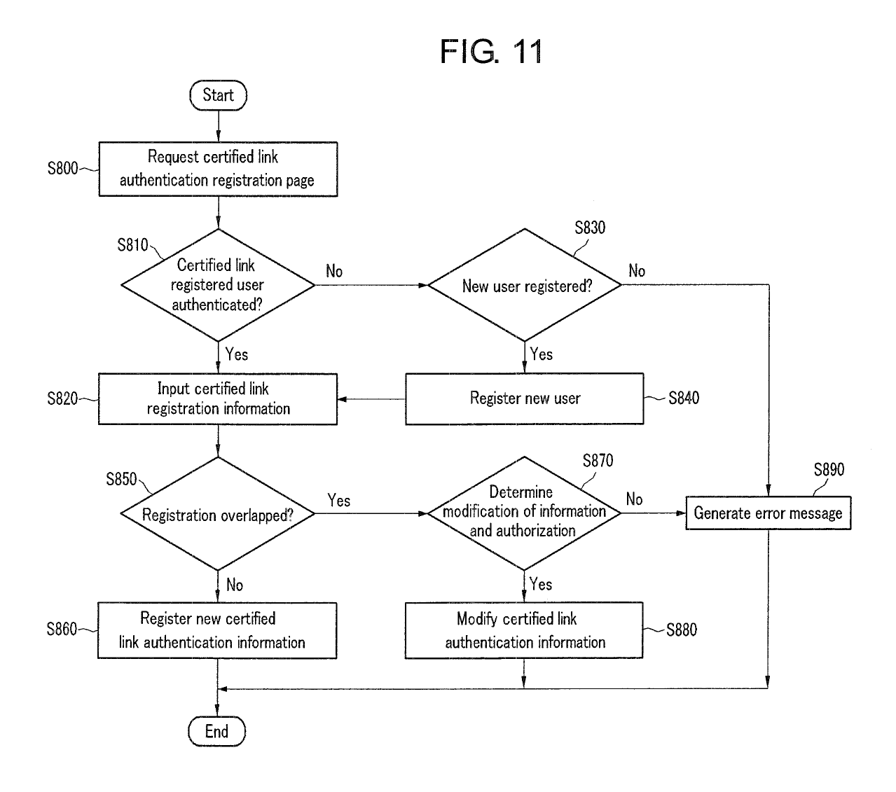

FIG. 11 is a diagram representing an operation of the registration information input unit 220 of the certified link authentication server 200 shown in FIG. 3.

As shown in FIG. 11, the registration information input unit 220 receives a request for a certified link authentication registration page from a user in step S800. Then, the user authentication unit 210 performs a user authentication process in step S810. In this case, when the user is registered in the certified link authentication server 200, the registration information input unit 220 receives certified link authentication information from the user in step S820. In addition, when the user is not registered in the certified link authentication server 200 in step S810, the user authentication unit 210 performs a new user registration process and registers the user in steps S830 to S840. The registration information input unit 220 determines overlapping registration from the certified link authentication information received from the certified link registered user in step S850. In this case, when it is not an overlapping registration, the registration information input unit 220 stores the certified link authentication information in the authentication information storage unit 240 to register new certified link authentication information in step S860. When it is overlapping registration, the registration information input unit 220 determines modification of the certified link authentication information from the certified link registered user while determining authorization for the overlapping registration, and modifies the certified link authentication information in steps S870 to S880. In this case, when there is no authorization for the overlapping registration, and the certified link registered user does not want to modify the certified link authentication information, or the user does not want to be registered as a new user in step S830, the registration information input unit 220 generates an error message, and certified link authentication information input is finished in step S890.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

As described, according to the exemplary embodiment of the present invention, reliability of a link may increase, and reliability of a web server and a web page that provide the link may increase. Accordingly, personal information leakage and a reliability decrease may be prevented.

1. A method for displaying an authenticated certified link on a web page requested by a terminal from a web server, the method comprising:
parsing the web page and extracting markup information for a certified link;
using the extracted markup information and requesting authentication for the certified link;
marking the authenticated certified link with a certified mark; and
rendering the web page including the certified link marked with the certified mark and displaying the web page.

2. The method of claim 1, further comprising marking a certified link that is not authenticated with a non-certified mark.

3. The method of claim 2, further comprising marking a uniform resource locator (URL) address window of the web page including the certified link with the certified mark or the non-certified mark according to the authentication.

4. The method of claim 2, further comprising marking a submit button in the web page with the certified mark or the non-certified mark according to the authentication.

5. The method of claim 2, further comprising blocking a link connection of the certified link marked with the non-certified mark.

6. The method of claim 2, further comprising displaying a warning message on an input window in which user information is input in the web page including the certified link marked with the non-certified mark.

7. A method for authenticating a certified link of a web page in a certified link authentication server that accesses a plurality of terminals through the Internet, the method comprising:
registering certified link authentication information of the web page received from a terminal of a certified link registered user among the plurality of terminals through the Internet;
receiving a request for authenticating the certified link from a terminal of a certified link authentication requesting user among the plurality of terminals;
authenticating the certified link based on the registered certified link authentication information; and
transmitting an authentication result to the terminal a certified link authentication requesting user.

8. The method of claim 7, wherein the registering of the certified link authentication information comprises:
authenticating a certified link registered user;
receiving certified link authentication information from the authenticated certified link registered user;
determining whether the received certified link authentication information is overlapped; and
registering the certified link authentication information when the received certified link authentication information is not overlapped.

9. The method of claim 8, further comprising modifying the certified link authentication information according to a modification state of certified link authentication information when the received certified link authentication information is overlapped.

10. The method of claim 7, wherein the certified link authentication information includes at least one among a link connection IP list, a link connection keyword list, an allowed web server IP list, and an allowed web server uniform resource locator (URL) list.

11. A terminal for displaying a certified link on a web page requested from a web server, the terminal comprising:
a rendering engine unit for parsing the web page to extract the certified link, marking an authenticated certified link with a certified mark, and marking a certified link that is not authenticated with a non-certified mark;
a certified link determination unit for requesting authentication for the extracted certified link, and transmitting an authentication result to the rendering engine unit; and
a graphic interface unit for displaying the certified link marked with the certified mark by the rendering engine unit.

12. The terminal of claim 11, wherein the rendering engine unit marks a uniform resource locator (URL) address input window with the certified mark in a web page including the certified link marked with the certified mark, and marks the URL address input window with the non-certified mark in a web page including the certified link marked with the non-certified mark.

13. The terminal of claim 12, wherein a predetermined tag or characteristic information that indicates the certified link is included in a markup language that describes the web page, and the rendering engine unit extracts the certified link from the predetermined tag or the characteristic information.

14. A certified link authentication server for authenticating a certified link of a web page requested by a terminal, the certified link authentication server comprising:
a user authentication unit for authenticating a certified link registered user requesting registration of the certified link;
a authentication information storage unit for storing the certified link registered user information and certified link authentication information;
a registration information input unit for receiving the certified link authentication information from the certified link registered user, and storing the certified link authentication information in the registration information storage unit; and
a certified link authentication processing unit for authenticating the certified link of the web page requested by the terminal based on the stored certified link authentication information, and transmitting an authentication result to the terminal.

15. The certified link authentication server of claim 14, wherein the registration information input unit determines whether the certified link authentication information received from the certified link registered user is overlapped, and modifies the certified link authentication information.
